(19) United States
(12) Patent Application Publication
(10) Pub. No.: US 2016/0167645 A1
(43) Pub. Date: Jun. 16, 2016

(54) APPARATUS AND METHOD OF CONTROLLING CONVERSION OF DRIVING MODE OF PLUG-IN HYBRID ELECTRIC VEHICLE

(71) Applicant: Hyundai Motor Company, Seoul (KR)

(72) Inventor: Joon Young Park, Seoul (KR)

(21) Appl. No.: 14/867,260

(22) Filed: Sep. 28, 2015

(30) Foreign Application Priority Data
Dec. 12, 2014 (KR) 10-2014-0178911
Dec. 29, 2014 (KR) 10-2014-0191908

(51) Int. Cl. B60W 20/20; B60K 6/48

(52) U.S. Cl. CPC B60W 20/20; B60K 6/48; Y10S 903/93

(57) ABSTRACT

The present disclosure provides an apparatus for controlling conversion of a driving mode of a plug-in hybrid electric vehicle including: a navigation apparatus outputting a travel route having a plurality of sections according to an input of a destination of the vehicle; and a controller measuring a state of charge (SOC) of a high voltage battery of the vehicle, calculating an all-electric range (AER) which the vehicle is capable of traveling in an electric vehicle driving mode according to the SOC of the high voltage battery, comparing the calculated AER and the travel route, and controlling the conversion of the driving mode by setting either a first driving mode or a second driving mode for each section of the travel route based on a travel condition when a distance of the travel route is greater than the calculated AER.

### CROSS-REFERENCE TO RELATED APPLICATIONS

This application claims under 35 U.S.C. §119(a) the benefit of Korean Patent Application No. 10-2014-0191908 filed on Dec. 29, 2014 and Korean Patent Application No. 10-2014-0178911 filed on Dec. 12, 2014, the entire contents of which are incorporated herein by reference.

### BACKGROUND

(a) Technical Field

The present disclosure relates generally to an apparatus and a method of controlling conversion of a driving mode of a plug-in hybrid electric vehicle. More particularly, it relates to a technique for mutually controlling conversion of a driving mode into a first driving mode and a second driving mode according to a charge quantity of a high voltage battery when setting a travel route in consideration of a travel condition.

(b) Background Art

A typical hybrid electric vehicle is composed of an engine and a motor as driving sources for the vehicle and includes an inverter, a DC/DC converter, a high voltage battery, and the like for operations of the engine and the motor. The typical hybrid electric vehicle also includes a hybrid control unit (HCU), a motor control unit (MCU), a battery management system (BMS), and the like as control means. A high voltage battery is an energy source for driving the motor and the DC/DC converter of the hybrid electric vehicle, and the BMS thereof monitors a voltage, a current, and a temperature of the high voltage battery and adjusts a state of charge (SOC) of the high voltage battery.

As is well known in the art, the main driving mode of a hybrid electric vehicle includes an electric vehicle driving mode for a pure electric vehicle using only power of the motor and a hybrid electric vehicle driving mode that is an auxiliary mode using rotational force of the engine as a main power source and rotational force of the motor as an auxiliary power source. The hybrid electric vehicle driving mode includes a regenerative braking (RB) mode for collecting braking and inertial energy of the vehicle while travelling which is utilized by the motor for charging the battery using the collected energy.

Recently, research has been conducted on different driving modes, including a charge depleting (CD) driving mode accompanying consumption of an SOC of a battery and a charge sustaining (CS) driving mode for maintaining an SOC of the battery. As described above, a high voltage battery of a plug-in hybrid electric vehicle may be charged from an external power source. However, an all-electric range movable by an SOC of the battery through external charging is limited. Accordingly, the plug-in hybrid electric vehicle can travel in the CD driving mode consuming an SOC of a driving battery when an SOC of the battery is greater than or equal to a predetermined SOC of the battery, and then can travel in the CS driving mode maintaining an SOC when the SOC of the battery is less than the predetermined SOC of the battery.

Among the methods of improving fuel efficiency of a hybrid electric vehicle, a method has been developed for changing an output to a section in which efficiency is high when the vehicle needs to be driven with a low-output region in which efficiency of an engine is low, and the remaining output is generated as electricity by a motor to charge a battery (Korean Patent No. 10-0491572, hereinafter, referred to as “Document 1”). That is, a lower limit is set in engine target power, and an engine is not operated within a low output range in which efficiency for an output of the engine is low and a change in efficiency for an output change of the engine is relatively high, so that it is possible to improve fuel efficiency and efficiency of the engine. Further, a value at which efficiency for the output of the engine is optimum efficiency is set, so that it is possible to further improve fuel efficiency of the engine, and charge the battery by using residual power and setting the lower limit to the engine target power.

However, Document 1 fails to provide a technique for determining a travel condition and setting a driving mode according to each route. Further, Document 1 fails to provide a technique for determining an all-electric range (AER) for travelling in an electric vehicle driving mode by considering an SOC of the battery of the vehicle, comparing the determined AER with a travel route, and setting a driving mode on the travel route. Accordingly, when a driving mode of a vehicle is simply set in consideration of an SOC of a high voltage battery, there can be a problem in that the vehicle cannot travel in the CD driving mode in a section demanding high efficiency. Thus, it can be impossible to improve fuel efficiency of a plug-in hybrid electric vehicle. Further, because a travel condition cannot be considered, an output demand of a driver may not be adequately responded to.

The above information disclosed in this Background section is only for enhancement of understanding of the background of the disclosure, and therefore, it may contain information that does not form the related art that is already known to a person of ordinary skill in the art.

### SUMMARY OF THE DISCLOSURE

The present disclosure has been made in an effort to solve the above-described problems associated with the related art and provides techniques for enabling a vehicle to travel with high efficiency according to a travel route of a plug-in hybrid electric vehicle by calculating an all-electric range (AER) according to a state of charge (SOC) of a high voltage battery of a vehicle and setting a travel route by reflecting a travel condition to a target point. Further, a driving mode can be set for each section of the travel route to set a route requiring a high load and high-speed travelling in a CS driving mode that is a second driving mode, and set a route requiring a low load and low-speed travelling in a CD driving mode that is a first driving mode.

According to embodiments of the present disclosure, an apparatus for controlling conversion of a driving mode of a plug-in hybrid electric vehicle, includes: a navigation apparatus outputting a travel route having a plurality of sections according to an input of a destination of the vehicle; and a controller measuring a state of charge (SOC) of a high voltage battery of the vehicle, calculating an all-electric range (AER) which the vehicle is capable of traveling in an electric vehicle driving mode according to the SOC of the high voltage battery, comparing the calculated AER and the travel route, and controlling the conversion of the driving mode by setting either a first driving mode or a second driving mode for each section of the travel route based on a travel condition when a distance of the travel route is greater than the calculated AER.

The controller may control the conversion between the first driving mode and the second driving mode based on the SOC of the high voltage battery.

The controller may set the second driving mode when the SOC of the high voltage battery of the vehicle is less than a preset reference value.

The controller may set the second driving mode in a high load or high-speed travel condition and sets the first driving mode under a low load or low-speed travel condition.

The controller may receive the travel condition of the travel route through telematics communication.

A first demanded driving quantity by which the electric vehicle driving mode is converted into a hybrid electric vehicle driving mode in the first driving mode may be greater than a second demanded driving quantity by which the electric vehicle driving mode is converted into the hybrid electric vehicle driving mode in the second driving mode.

The travel route may include a charging point positioned along the route heading toward the destination.

The controller may set the first driving mode when the distance of the travel route is less than the calculated AER.

Furthermore, according to embodiments of the present disclosure, a method of controlling conversion of a driving mode of a plug-in hybrid electric vehicle, includes: receiving, at a navigation apparatus of the vehicle, a destination from a driver of the vehicle; receiving, at a controller in the vehicle, travel condition data through telematics communication; setting a travel route based on the received travel condition data; measuring a state of charge (SOC) of a high voltage battery of the vehicle calculating an all-electric range (AER) which the vehicle is capable of traveling in an electric vehicle driving mode according to the SOC of the high voltage battery of the vehicle; comparing the calculated AER and the travel route; and controlling the conversion of the driving mode by setting either a first driving mode or a second driving mode for each section of the travel route based on a travel condition according to the travel condition data when a distance of the travel route is greater than the calculated AER.

The method may further include converting the first driving mode into the second driving mode, when the vehicle travels in the first driving mode, and the SOC of the high voltage battery is less than or equal to than a preset reference value or the vehicle enters a second driving mode conversion section.

The method may further include setting the second driving mode, when the distance of the travel route is greater than the calculated AER, and the SOC of the high voltage battery is less than a preset reference value or a mode conversion in the travel route is needed.

The method may further include calculating a residual SOC of the high voltage battery when travelling is completed; and converting a second driving mode section into a first driving mode section using the residual SOC of the high voltage battery.

The method may further include setting the second driving mode in a high load or high-speed travel condition; and setting the first driving mode in a low load or low-speed travel condition.

The travel route includes a charging point positioned along the route heading toward the destination.

The method may further include setting the first driving mode when the distance of the travel route is less than the calculated AER.

Accordingly, the present disclosure describes techniques for setting a travel route in consideration of a travel condition of a plug-in hybrid electric vehicle, a travel route in consideration of a travel condition according to a high load, a low load, a high speed, and a low speed, and a driving mode of a vehicle according to a section in the travel route, thereby improving efficiency of driving by a driver. Techniques described herein may further set a driving mode based on a travel condition in terms of fuel efficiency, and a vehicle may travel in a charge depleting (CD) driving mode or a charge sustaining (CS) driving mode when a high output and high-speed travel are needed for an efficient operation of an SOC of a battery of the vehicle, thereby providing vehicle performance conforming to a driving request of a driver. Accordingly, it is possible to maintain an SOC of the high voltage battery at a reference value or more while converting between the CD driving mode and the CS driving mode, thereby improving durability of the high voltage battery.

Other aspects and preferred embodiments of the disclosure are discussed infra.

### BRIEF DESCRIPTION OF THE DRAWINGS

The above and other features of the present disclosure will now be described in detail with reference to certain embodiments thereof illustrated in the accompanying drawings which are given hereinbelow by way of illustration only, and thus are not limitative of the present disclosure, and wherein:

FIG. 1 is a block diagram of a driving mode conversion control apparatus of a plug-in hybrid electric vehicle of the present disclosure;

FIG. 2A illustrates a vehicle travelling through a first driving mode when external charging is performed and an all-electric range (AER) is larger than a distance of a travel route according to a state of charge (SOC) of the high voltage battery;

FIG. 2B illustrates a point, at which the first driving mode is converted into a second driving mode, according to a travel distance when external charging is performed and a distance of the travel route is larger than an AER according to a state of charge (SOC) of the high voltage battery;

FIG. 3A illustrates sections up to a destination in which a first driving mode and a second driving mode are set according to a related art;

FIG. 3B illustrates sections in which a first driving mode and a second driving mode are set in consideration of a travel condition up to a destination according to embodiments of the present disclosure;

FIG. 4 is a flowchart illustrating a method of setting a travel route, and making a vehicle travel by converting a first driving mode and a second driving mode based on a relationship between the set travel route and an AER according to embodiments of the present disclosure;

FIG. 5 is a flowchart illustrating performance of the conversion between the first driving mode and the second driving mode according to embodiments of the present disclosure; and

FIG. 6 illustrates an operation of converting the precedent second driving mode into the first driving mode when a residual SOC of a high voltage battery exists when setting a route according to embodiments of the present disclosure.

Reference numerals set forth in the Drawings include reference to the following elements as further discussed below:
10: controller
20: motor
30: engine
40: high voltage battery
50: navigation apparatus

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. Reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with embodiments, it will be understood that present description is not intended to limit the disclosure to those embodiments. On the contrary, the disclosure is intended to cover not only the exemplary embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Hereinafter, embodiments of the present disclosure will be described in detail with reference to the accompanying drawings so that those with ordinary skill in the art to which the present disclosure pertains may easily carry out the embodiments.

The present disclosure describes techniques for setting a travel route in consideration of a travel condition, and provides techniques for setting a travel condition according to a high load and a low load, and further, a high speed and a low speed. Accordingly, the present disclosure operates a vehicle by setting a driving mode according to a travel condition of a travel route, so that improved fuel efficiency for a vehicle is achieved.

Among the driving modes, an electric vehicle driving mode is a driving mode in which electric energy is generated by a high voltage battery 40 and travelling force is obtained from a motor 20 which is driven by receiving the electric energy through an inverter and a DC/DC converter. That is, the electric vehicle driving mode is a driving mode using pure electric energy, in which an all-electric range (AER) is set according to a state of charge (SOC) of the high voltage battery 40 which is externally chargeable.

By contrast, a hybrid electric vehicle driving mode means a driving mode obtaining power through driving of an engine 30. While travelling in the hybrid electric vehicle driving mode, a battery may be charged through regenerative braking for uniformly charging the high voltage battery 40.

A plug-in hybrid electric vehicle includes a charge depleting (CD) driving mode for travelling a vehicle while consuming an SOC of a battery, and a charge sustaining (CS) driving mode for travelling a vehicle while maintaining the SOC of the battery when the SOC is less than or equal to than a predetermined SOC of the battery.

The present disclosure includes a first driving mode that is the CD driving mode when an SOC of the battery is equal to or larger than a pre-stored reference value. Further, the present disclosure includes a second driving mode that is the CS driving mode for traveling the vehicle while maintaining the SOC of the battery with a predetermined value when the SOC of the battery is equal to or smaller than the pre-stored reference value.

As described above, the first driving mode and the second driving mode includes all of the electric vehicle driving mode and the hybrid electric vehicle driving mode. However, the first driving mode has a larger value of a demanded driving quantity of a user, by which the electric vehicle driving mode is converted into the hybrid electric vehicle driving mode, than that of the second driving mode. That is, a demanded driving quantity, by which the electric vehicle driving mode is converted into the hybrid electric vehicle driving mode, while the vehicle travels in the first driving mode may be set as a first demanded driving quantity, and a demanded driving quantity, by which the electric vehicle driving mode is converted into the hybrid electric vehicle driving mode, while the vehicle travels in the second driving mode may be set as a second demanded driving quantity. The first demanded driving quantity has a larger value than that of the second demanded driving quantity. Accordingly, the first driving mode may enable the vehicle to travel in the electric vehicle driving mode and the second driving mode may enable the vehicle to travel in the hybrid electric driving vehicle mode according to the same demanded driving quantity.

As described above, in comparison of the first driving mode and the second driving mode, the first demanded driving quantity demanded in the first driving mode maintains a larger value than that of the second demanded driving quantity demanded in the second driving mode in order to maintain the electric vehicle driving mode according to an increase in demanded driving force of the user for a long time. By contrast, the second driving mode converts the electric vehicle driving mode into the hybrid electric vehicle driving mode in response to an increase in demanded driving force of the user. Accordingly, second demanded driving force may be set to a smaller value than that of first demanded driving force.

FIG. 1 is a block diagram of a driving mode conversion control apparatus of a plug-in hybrid electric vehicle of the present disclosure.

As illustrated, the driving mode conversion control apparatus of the plug-in hybrid electric vehicle includes the motor 20 and the engine 30 for providing driving force of the vehicle, a navigation apparatus 50 capable of establishing telematics communication, and a controller 10 capable of measuring an SOC of the high voltage battery 40, calculating an AER according to the measured SOC, and setting a driving mode according to a section of a travel route under a travel condition received through telematics communication.

The controller 10 receives destination data of the navigation apparatus 50, and receives a travel condition through telematics communication. The navigation apparatus 50 may use an advanced driver assistance system (ADAS) map. Further, the controller 10 calculates an AER according to an SOC of the high voltage battery 40, and compares a distance to a destination and the AER. Further, the controller 10 sets a driving mode of each section based on a travel route for each section set according to a travel condition.

For the travel route output based on the destination data input into the navigation apparatus 50, the controller 10 may output a travel route to the destination according to an input of a user, or output a travel distance to a charging station in the travel route heading toward the destination. The controller 10 is configured of a hybrid control unit (HCU), a motor control unit (MCU), a battery management system (BMS), and the like.

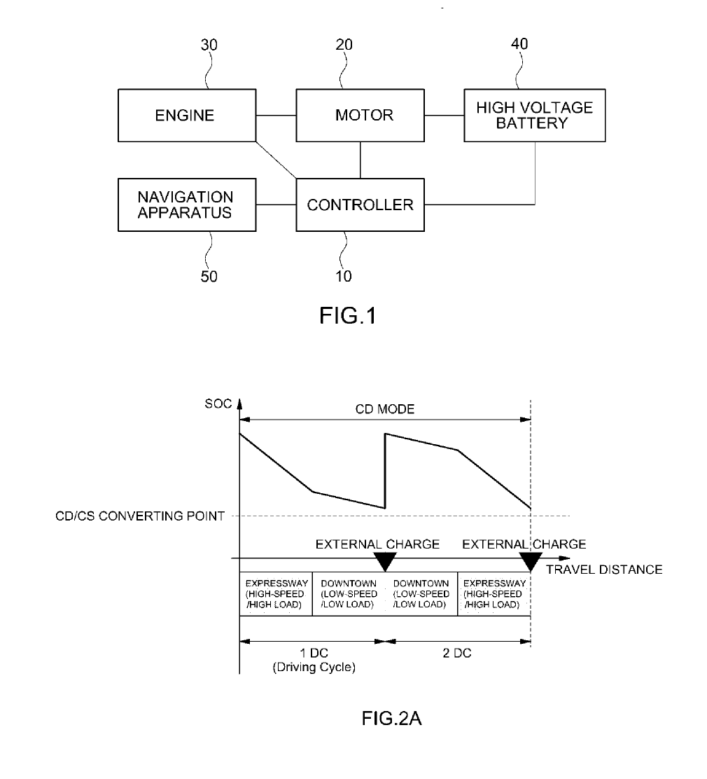

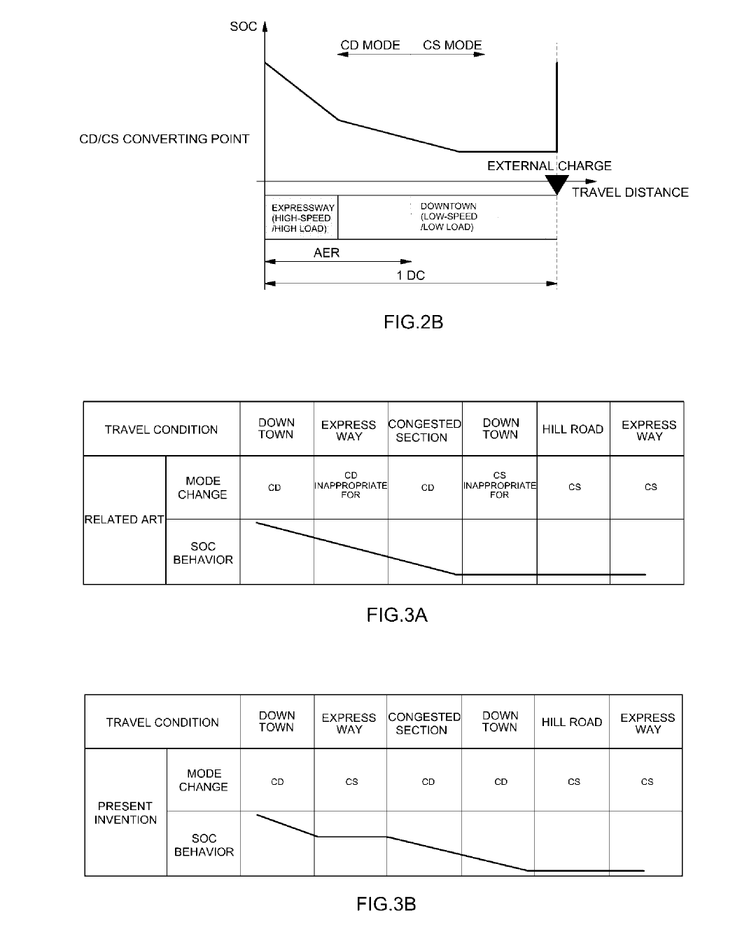

FIG. 2A illustrates a case where a travel route is equal to or smaller than an AER after the high voltage battery 40 is externally charged. That is, when the travel route is set within the AER according to the SOC of the high voltage battery 40 after the high voltage battery 40 is externally charged, the vehicle travels in the first driving mode.

By contrast, FIG. 2B illustrates a driving mode when a travel route exceeds the AER according to the SOC of the high voltage battery 40. When the vehicle has a travel route equal to or larger than the AER according to the external charging while travelling, the vehicle travels a first AER, and travels a distance exceeding the AER through the second driving mode. When the travel condition according to the travel route is not reflected, only the AER is simply calculated, and the driving mode is converted into the second driving mode at a distance equal to or larger than the AER as described above, fuel is inefficient.

FIG. 3A illustrates conversion of a driving mode of a plug-in hybrid electric vehicle, which does not reflect a route environment condition, according to a distance in the related art.

An AER is determined by an SOC of the high voltage battery 40. That is, a distance travelable in the electric vehicle driving mode until an initial SOC of the high voltage battery 40 is smaller than a reference value set in the controller 10 is determined as the AER.

The vehicle is driven in the first driving mode according to the setting of the route of the vehicle, so that the motor 20 driven by the SOC of the high voltage battery 40 is operated until the distance reaches the initial AER. Then, when the high voltage battery 40 has the SOC equal to or smaller than a reference value preset in the controller 10, the first driving mode of the vehicle is converted into the second driving mode, and the vehicle travels so that a predetermined SOC of the high voltage battery 40 is maintained.

When a high load or high-speed driving is demanded, a system efficiency characteristic is excellent in the second driving mode. By contrast, in a section in which a low load or low-speed driving is demanded, the first driving mode has an advantage in terms of a system efficiency characteristic. However, when the driving mode is simply converted according to the AER without reflecting the travel condition as described above, there is a problem in that fuel is inefficiently consumed while travelling an expressway within the AER and in a downtown travel section after the conversion of the driving mode into the second driving mode.

FIG. 3B illustrates embodiments of the present disclosure reflecting a travel condition. That is, when the travel route includes the same road route as that of FIG. 3A, the vehicle travels in the second driving mode when travelling the expressway that is the second section, and travels in the first driving mode while travelling in a downtown area that is the fourth section, so that the present disclosure provides a technique for setting a driving mode according to a load demanded for a route which the vehicle travels.

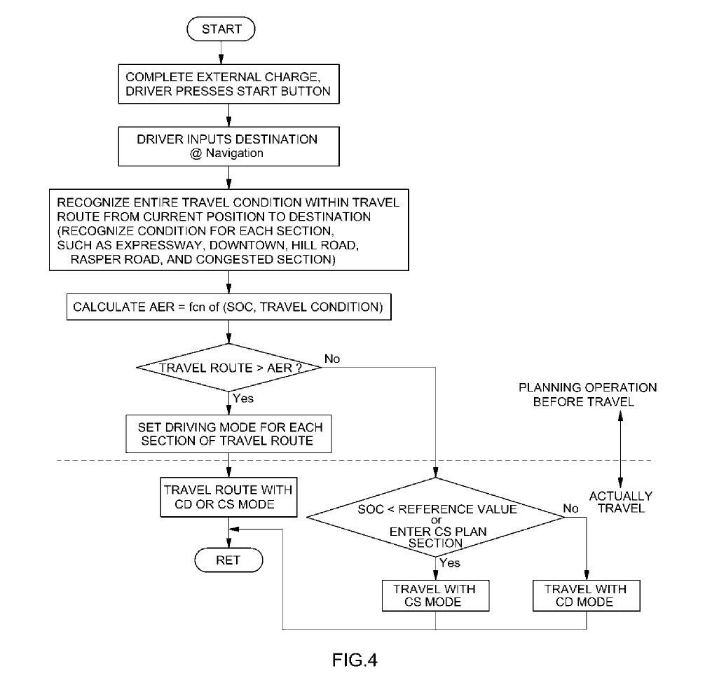

FIG. 4 is a block diagram of a driving mode conversion control method of the plug-in hybrid electric vehicle of the present disclosure.

When external charging is completed or the high voltage battery 40 has a predetermined charging quantity, a driver starts the vehicle (S101), and the driver inputs a destination into the navigation apparatus 50 (S102). The navigation apparatus 50 receives a travel condition through telematics communication (S103). The received travel condition includes the type of road, i.e., a hilly road, dirt road, etc., real-time traffic flow, and the like.

The controller 10 measures an SOC of the high voltage battery 40 based on the received travel condition and calculates an AER (S104). Further, the controller 10 compares the calculated AER and a distance of a travel route to the destination input into the navigation apparatus 50 (S105). When the distance of the travel route to the destination has a larger value than that of the AER, the controller 10 sets a driving mode according to the set travel route by reflecting a travel condition (S106), and the vehicle travels according to the driving mode set for each section of the travel route (S107).

However, when the distance of the travel route set to the destination has a smaller value than that of the AER (S105), the vehicle travels in the first driving mode. When the SOC of the high voltage battery 40 has a value less than or equal to than a reference value preset in the controller 10 or the plug-in hybrid electric vehicle performing the first driving mode enters a section in which the vehicle is set to travel in the second driving mode, the controller 10 converts the current first driving mode into the second driving mode and the vehicle travels.

When the SOC of the high voltage battery 40 maintains a value greater than or equal to than the reference value preset in the controller 10 and the vehicle does not enter the section in which the vehicle is set to travel in the second driving mode, the vehicle travels while maintaining the first driving mode that is the current driving mode (S110).

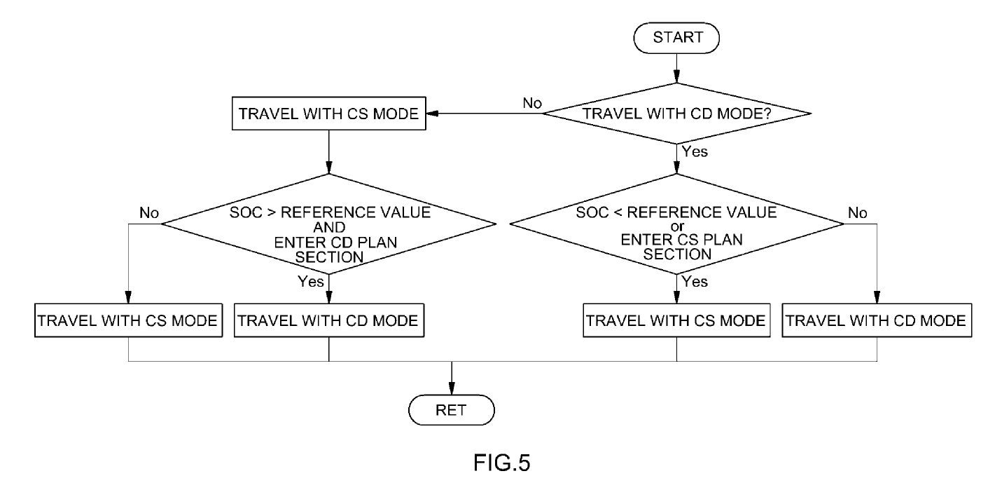

FIG. 5 is a flowchart illustrating setting a driving mode of a vehicle when a distance of a set travel route is larger than an AER.

When a distance of a travel route set to a destination is larger than an AER, the vehicle travels the set travel route according to a driving mode of the vehicle, so that the driving mode is set according to a section of the travel route by reflecting the travel condition. Accordingly, it is determined whether an initial driving mode is the first driving mode (S201). When the initial driving mode is not the first driving mode, the vehicle currently travels in the second driving mode (S202).

When the current driving mode is the second driving mode, it is determined whether the vehicle enters a first driving mode section (S203). When the vehicle enters the first driving mode section, the controller 10 converts the second driving mode into the first driving mode and the vehicle travels (S205), and when the vehicle does not enter the first driving mode section, the vehicle continuously travels in the second driving mode that is the current driving mode (S204).

However, when the initial driving mode is the first driving mode, it is determined whether the SOC of the high voltage battery 40 is less than or equal to than a preset reference value or whether the vehicle enters a second driving mode section (S206). When the SOC of the high voltage battery 40 is equal to or smaller than the preset reference value or whether the vehicle enters the second driving mode section, the controller 10 converts the driving mode of the vehicle into the second driving mode and the vehicle travels (S207), and when the SOC of the high voltage battery 40 is greater than the preset reference value or whether the vehicle does not enter the second driving mode section, the vehicle travels in the second driving mode (S208).

In the setting of the driving mode, the controller 10 performs the logic, and then performs an initial start operation through a return command again (S209). The logic repetition is terminated when the vehicle reaches the destination.

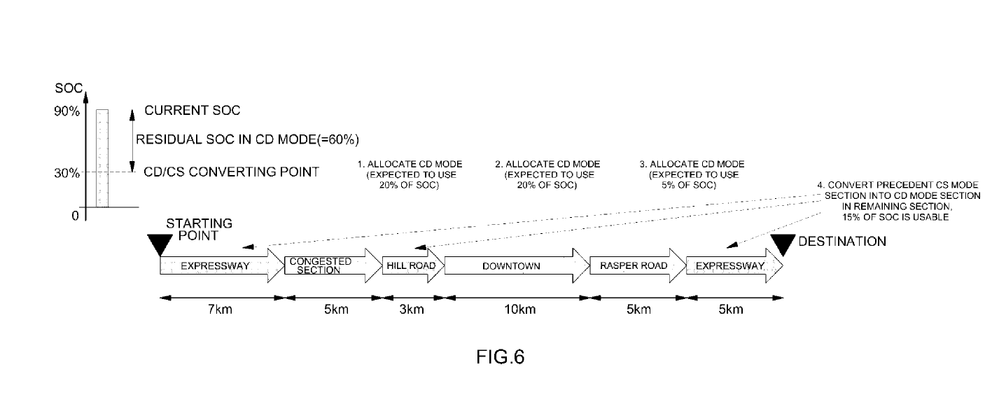

FIG. 6 illustrates embodiments in which a travel route according to a conversion plan of a driving mode is set in consideration of a travel condition, and when the high voltage battery 40 has the residual SOC when the vehicle reaches a destination, the precedent second driving mode is converted into the first driving mode.

According to the embodiments, when an SOC before travelling is 90%, a travel route according to a conversion plan of the driving mode is set in consideration of a travel condition, and then the residual SOC is 15%, the precedent second driving mode is converted into the first driving mode.

As described above, the second driving mode in the most precedent section of the travel route is converted into the first driving mode, in such a manner that the controller 10 converts the second driving mode into the first driving mode so that the high voltage battery 40 has the same residual SOC as the reference value preset in the controller 10. Further, the second driving mode is converted into the first driving mode according to the residual SOC, so that it is possible to minimize a fuel consumption section according to the second driving mode, thereby being advantageous in terms of fuel efficiency.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. An apparatus for controlling conversion of a driving mode of a plug-in hybrid electric vehicle, comprising:
a navigation apparatus outputting a travel route having a plurality of sections according to an input of a destination of the vehicle; and
a controller measuring a state of charge (SOC) of a high voltage battery of the vehicle, calculating an all-electric range (AER) which the vehicle is capable of traveling in an electric vehicle driving mode according to the SOC of the high voltage battery, comparing the calculated AER and the travel route, and controlling the conversion of the driving mode by setting either a first driving mode or a second driving mode for each section of the travel route based on a travel condition when a distance of the travel route is greater than the calculated AER.

2. The apparatus of claim 1, wherein the controller controls the conversion between the first driving mode and the second driving mode based on the SOC of the high voltage battery.

3. The apparatus of claim 2, wherein the controller sets the second driving mode when the SOC of the high voltage battery of the vehicle is less than a preset reference value.

4. The apparatus of claim 1, wherein the controller sets the second driving mode in a high load or high-speed travel condition and sets the first driving mode under a low load or low-speed travel condition.

5. The apparatus of claim 1, wherein the controller receives the travel condition of the travel route through telematics communication.

6. The apparatus of claim 1, wherein a first demanded driving quantity by which the electric vehicle driving mode is converted into a hybrid electric vehicle driving mode in the first driving mode is greater than a second demanded driving quantity by which the electric vehicle driving mode is converted into the hybrid electric vehicle driving mode in the second driving mode.

7. The apparatus of claim 1, wherein the travel route includes a charging point positioned along the route heading toward the destination.

8. The apparatus of claim 1, wherein the controller sets the first driving mode when the distance of the travel route is less than the calculated AER.

9. A method of controlling conversion of a driving mode of a plug-in hybrid electric vehicle, comprising:
receiving, at a navigation apparatus of the vehicle, a destination from a driver of the vehicle;
receiving, at a controller in the vehicle, travel condition data through telematics communication;
setting a travel route based on the received travel condition data;
measuring a state of charge (SOC) of a high voltage battery of the vehicle
calculating an all-electric range (AER) which the vehicle is capable of traveling in an electric vehicle driving mode according to the SOC of the high voltage battery of the vehicle;
comparing the calculated AER and the travel route; and
controlling the conversion of the driving mode by setting either a first driving mode or a second driving mode for each section of the travel route based on a travel condition according to the travel condition data when a distance of the travel route is greater than the calculated AER.

10. The method of claim 9, further comprising:
converting the first driving mode into the second driving mode, when the vehicle travels in the first driving mode, and the SOC of the high voltage battery is less than or equal to than a preset reference value or the vehicle enters a second driving mode conversion section.

11. The method of claim 9, further comprising:
setting the second driving mode, when the distance of the travel route is greater than the calculated AER, and the SOC of the high voltage battery is less than a preset reference value or a mode conversion in the travel route is needed.

12. The method of claim 9, further comprising:
calculating a residual SOC of the high voltage battery when travelling is completed; and
converting a second driving mode section into a first driving mode section using the residual SOC of the high voltage battery.

13. The method of claim 9, further comprising:
setting the second driving mode in a high load or high-speed travel condition; and
setting the first driving mode in a low load or low-speed travel condition.

14. The method of claim 9, wherein the travel route includes a charging point positioned along the route heading toward the destination.

15. The method of claim 9, further comprising:
setting the first driving mode when the distance of the travel route is less than the calculated AER.
